(19) United States
(12) Patent Application Publication
(10) Pub. No.: US 2026/0128758 A1
(43) Pub. Date: May 7, 2026

(54) SEMICONDUCTOR DEVICE AND COMMUNICATION SYSTEM

(71) Applicant: ROHM CO., LTD., Kyoto (JP)

(72) Inventor: Kei Nagao, Kyoto (JP)

(21) Appl. No.: 19/436,540

(22) Filed: Dec. 30, 2025

Related U.S. Application Data
(63) Continuation of application No. PCT/JP2024/021377, filed on Jun. 12, 2024.

(30) Foreign Application Priority Data
Jul. 6, 2023 (JP) 2023-111351

(51) Int. Cl. H04B 1/40

(52) U.S. Cl. CPC H04B 1/40

(57) ABSTRACT

A semiconductor device includes a receiver configured to externally receive communication data by serial communication, and a controller. In the semiconductor device, its group is settable. The communication data includes first data indicating whether broadcasting is in progress and second data indicating the group of a semiconductor device. If the group set in the controller’s own semiconductor device matches the group indicated by the second data, the controller judges that broadcasting is in progress for the controller’s own semiconductor device.

### CROSS-REFERENCE TO RELATED APPLICATIONS

This nonprovisional application is a continuation application of International Patent Application No. PCT/JP2024/021377 filed on June 12, 2024, which claims priority to Japanese Patent Application No. 2023-111351 filed on July 6, 2023, the entire contents of which are hereby incorporated by reference.

### TECHNICAL FIELD

The present disclosure relates to a semiconductor device and a communication system.

### BACKGROUND ART

Semiconductor devices with a serial communication function are used in various applications.

Patent Document 1 discloses one example of a circuit technology relating to serial communication.

### Citation List

### Patent Literature

Patent Document 1: JP 2017-224946 A1

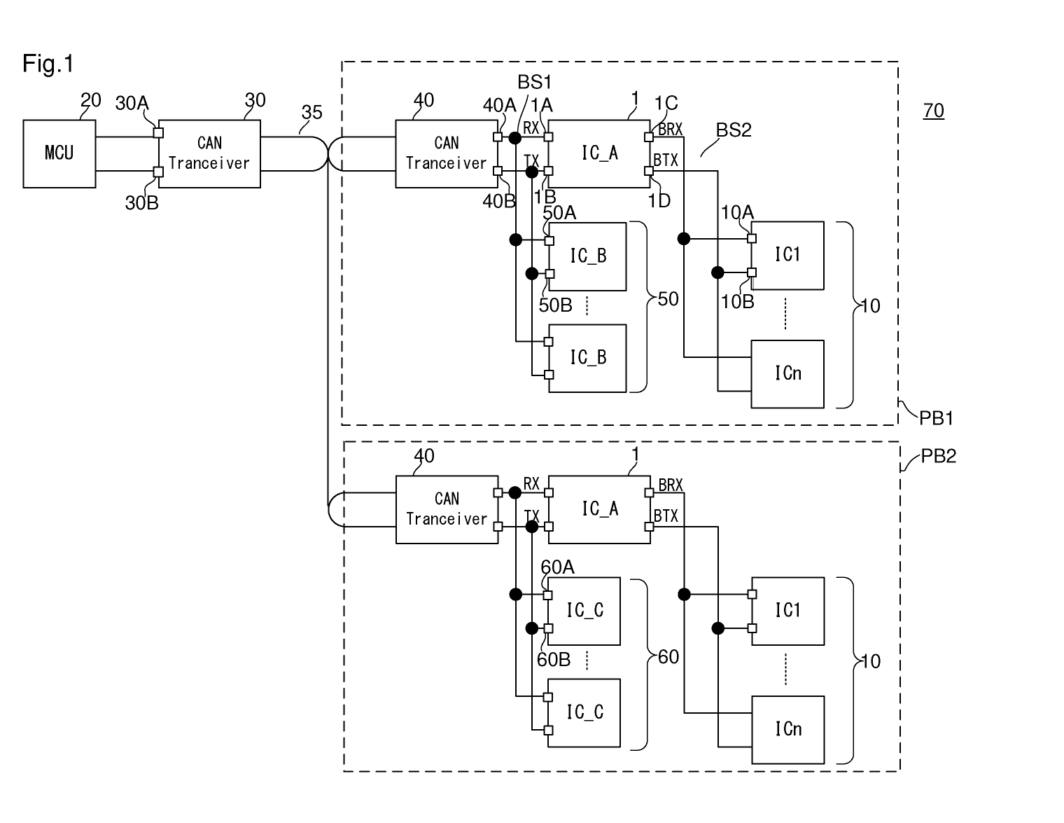

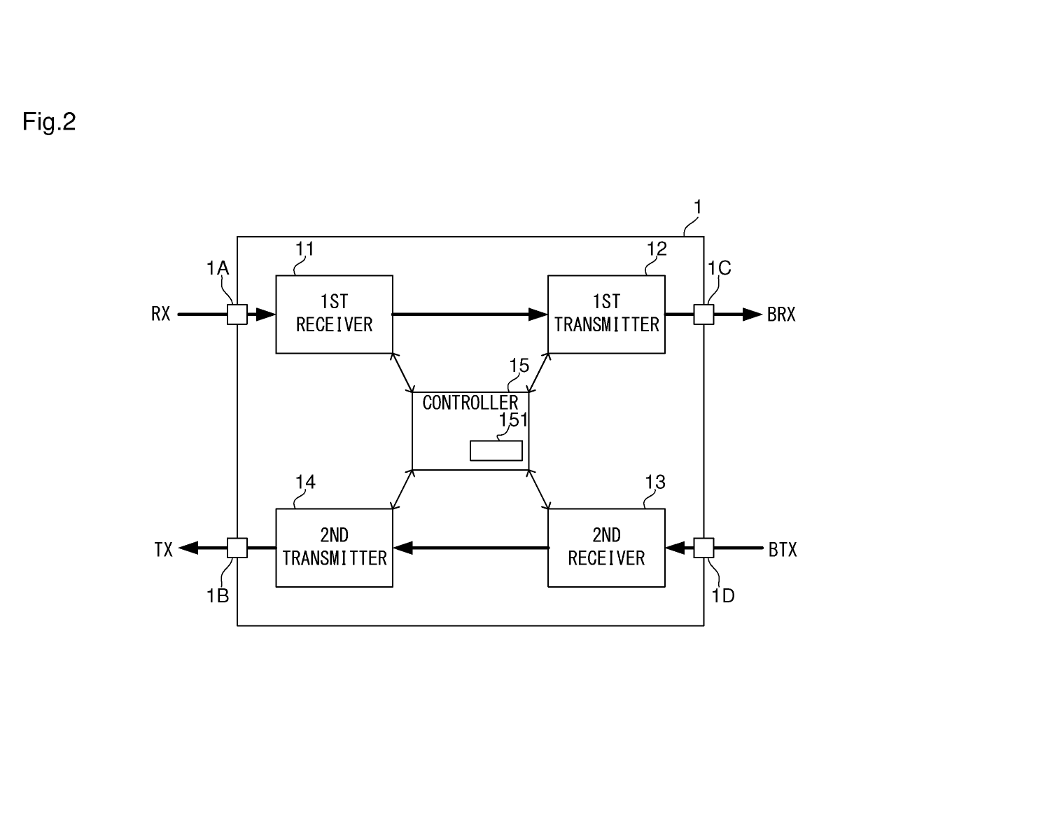

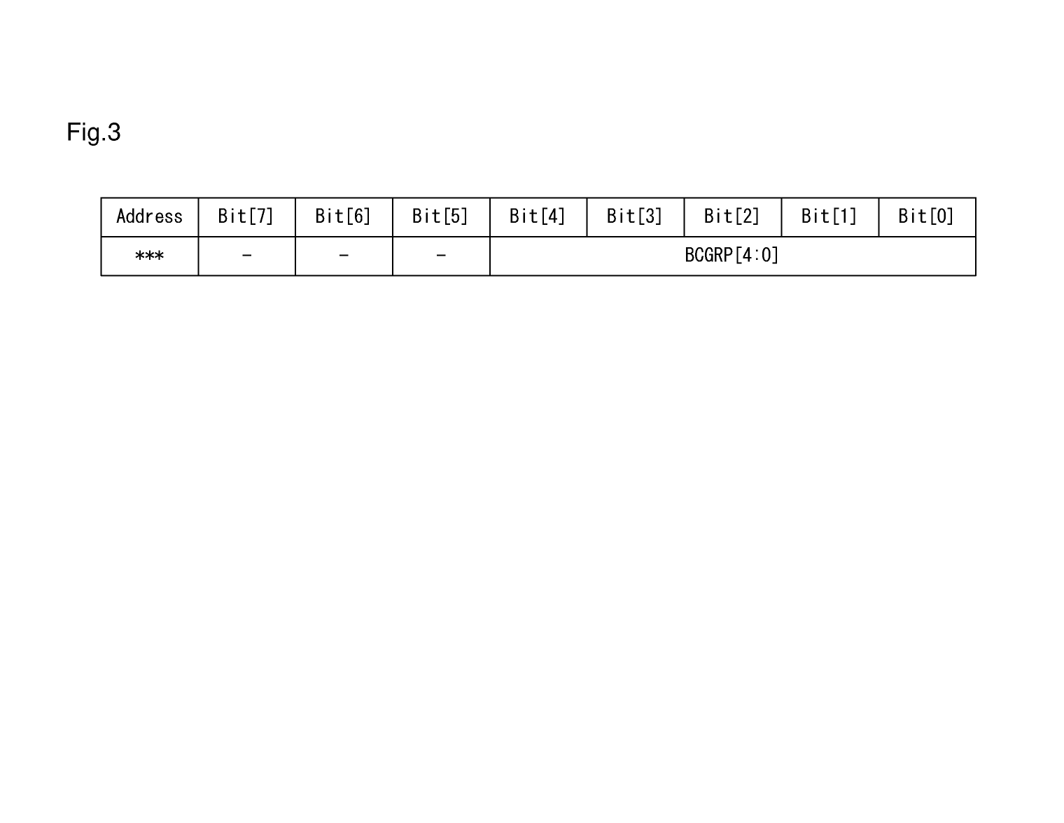

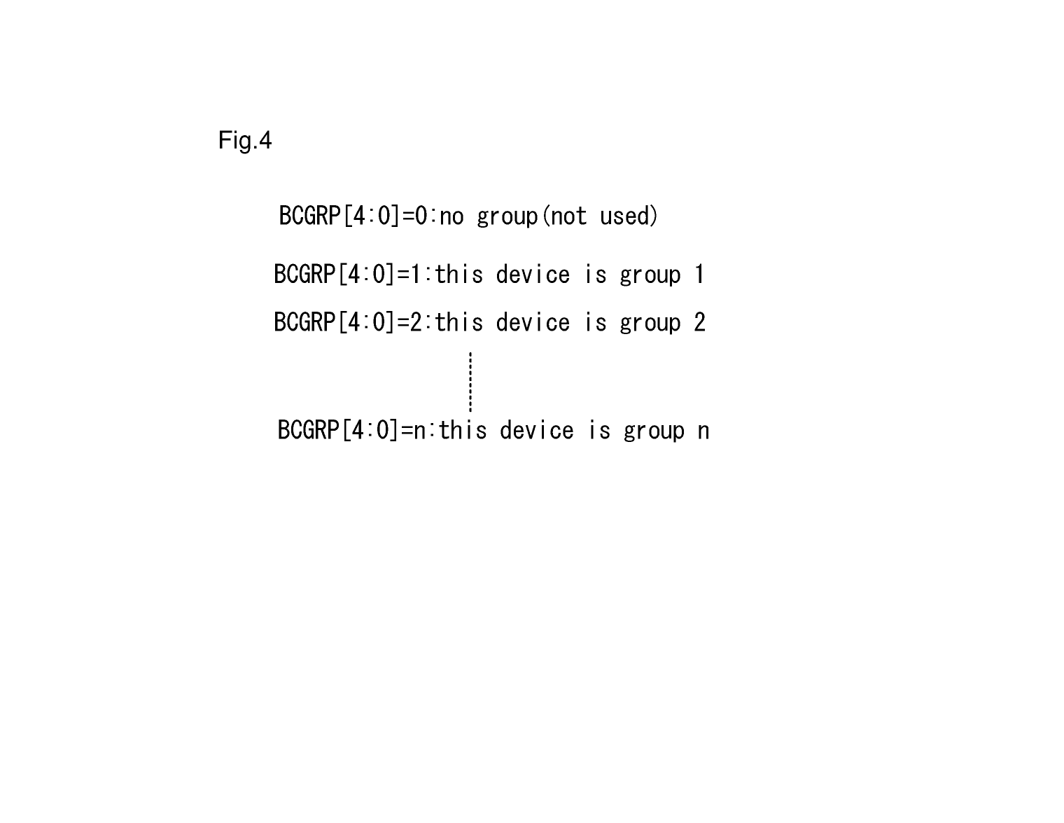

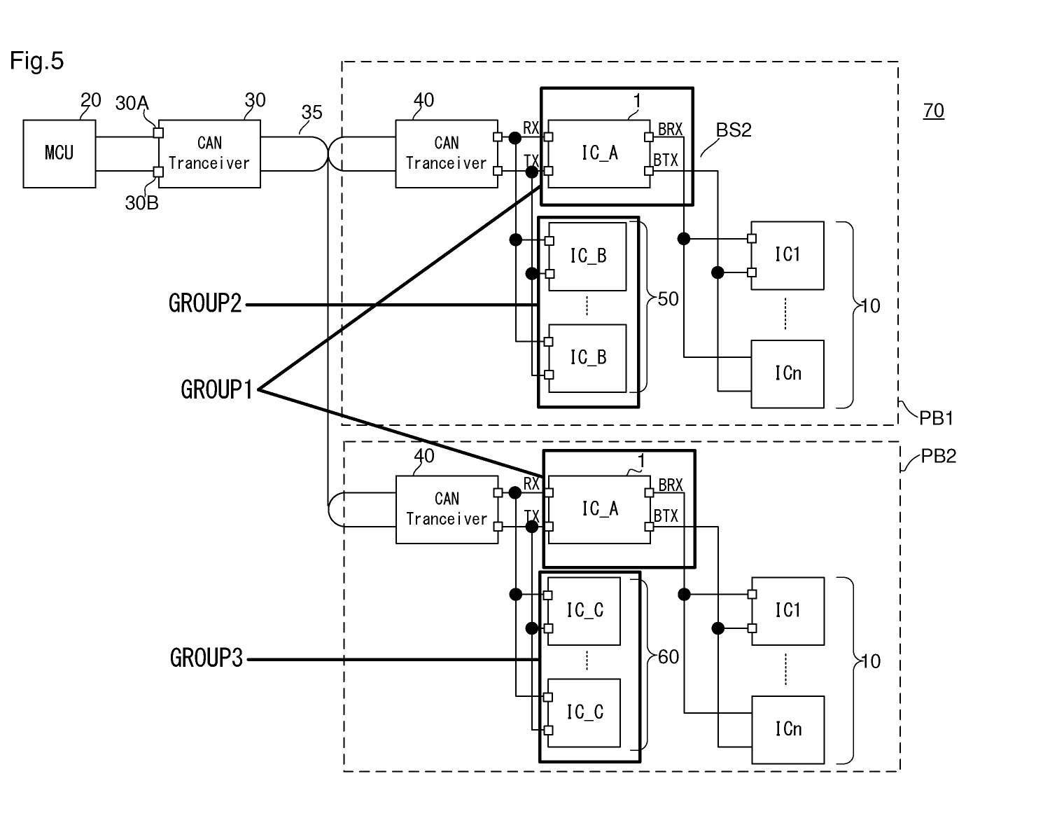

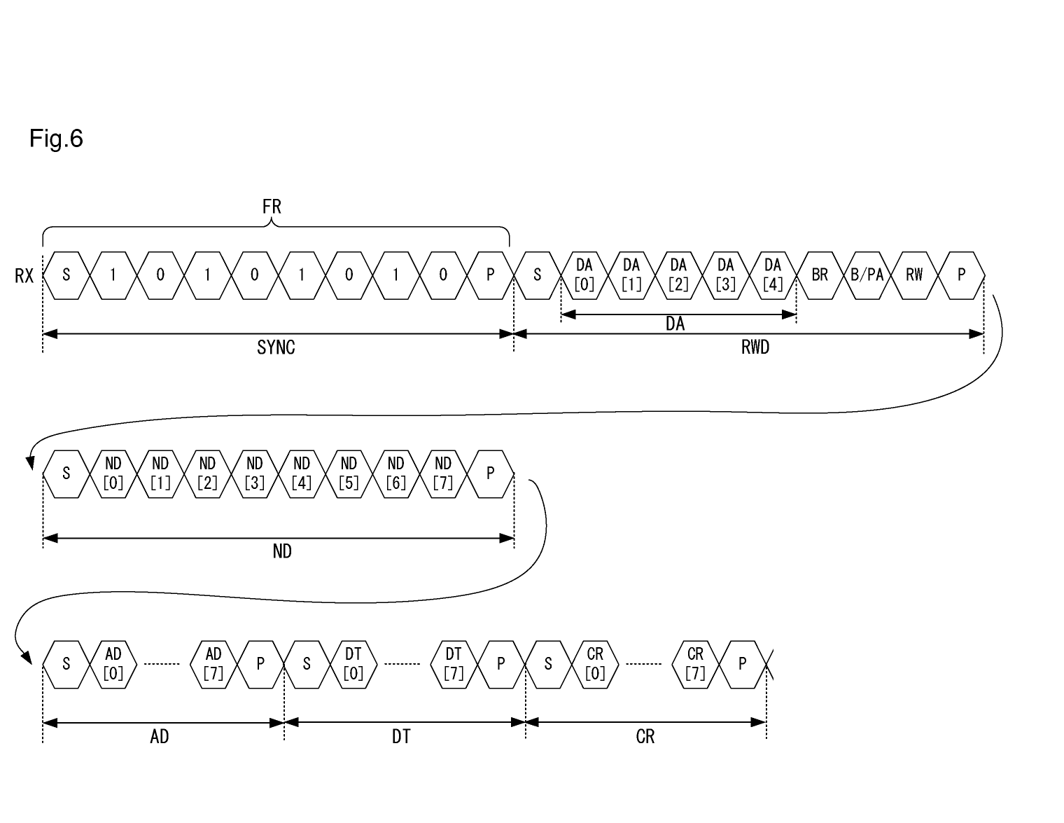

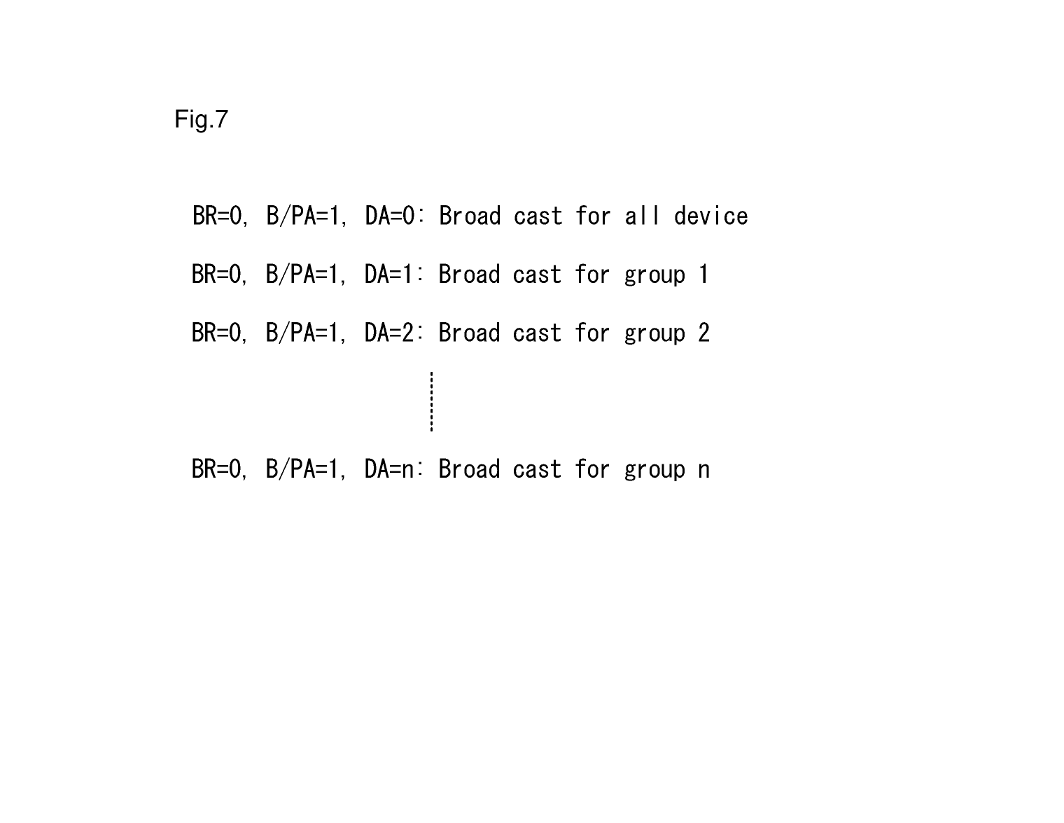

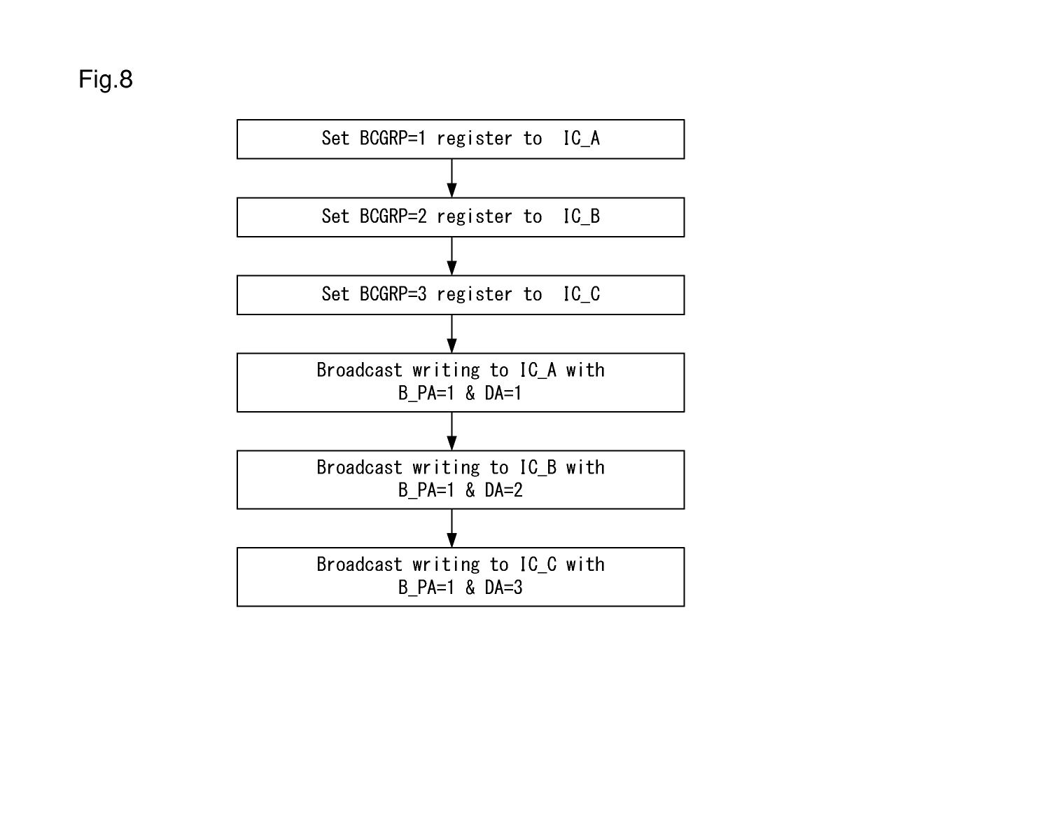

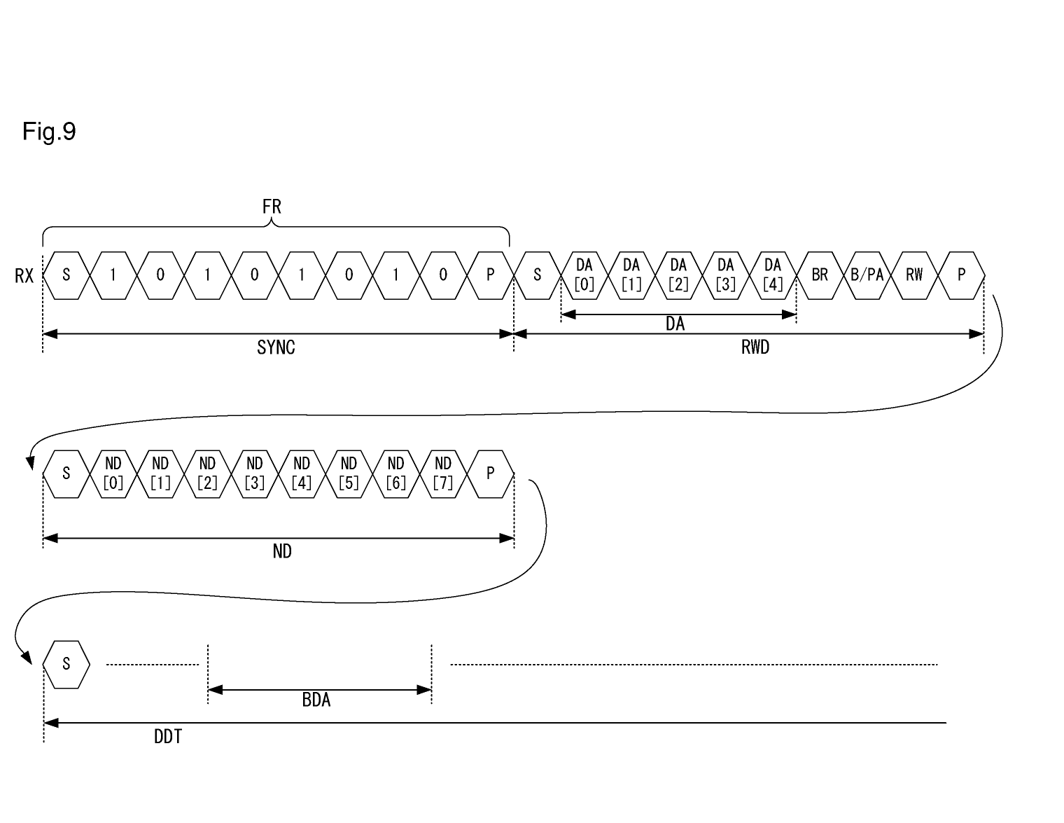

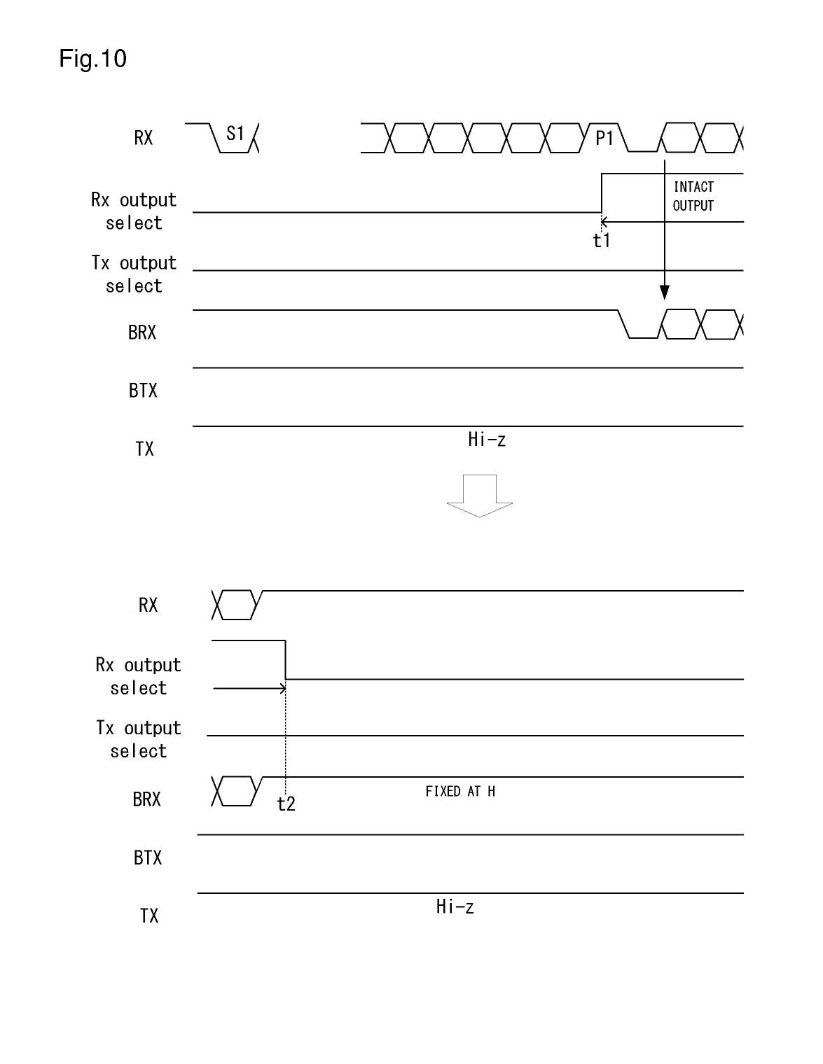

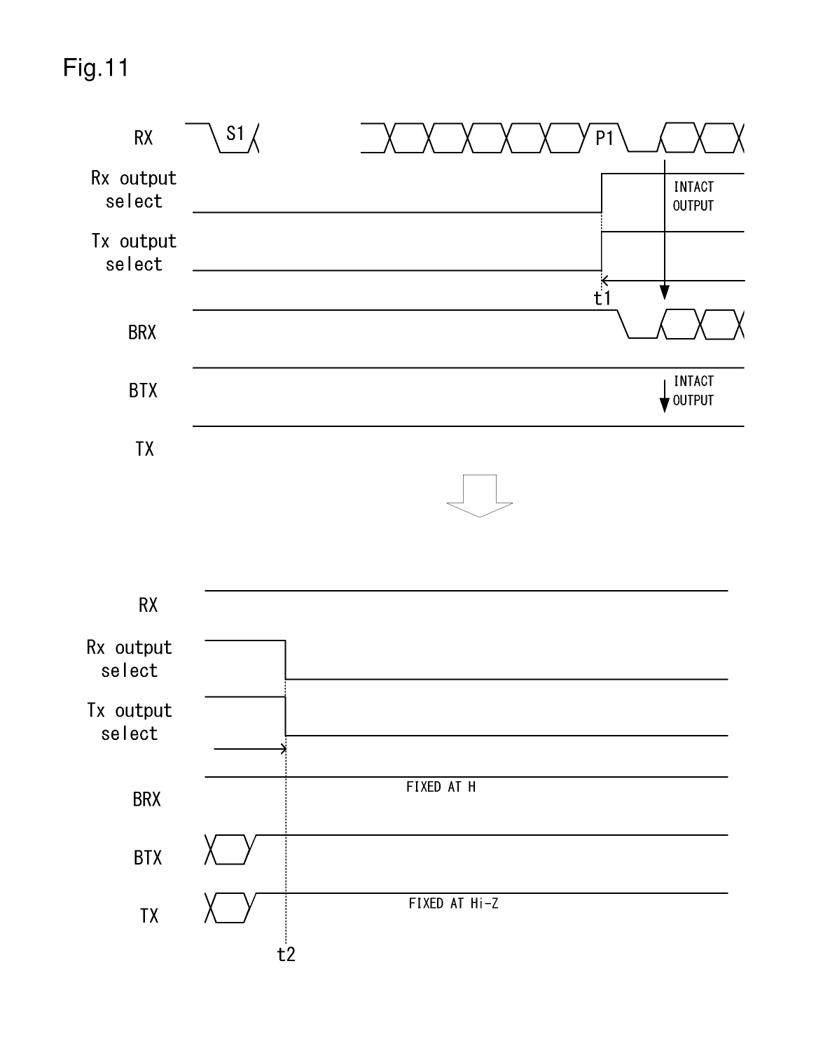

### BRIEF DESCRIPTION OF DRAWINGS

[FIG. 1] FIG. 1 is a diagram showing the configuration of a communication system according to an illustrative embodiment of the present disclosure.

[FIG. 2] FIG. 2 is a block diagram of a semiconductor device according to the illustrative embodiment of the present disclosure.

[FIG. 3] FIG. 3 is a register map relating to the grouping function in a register in the semiconductor device.

[FIG. 4] FIG. 4 is a diagram showing one example of the correspondence between values of group setting data and groups to be set.

[FIG. 5] FIG. 5 is a diagram showing one example of grouping of semiconductor devices.

[FIG. 6] FIG. 6 is a diagram showing a data structure of reception data RX in a case where a write is performed with a semiconductor device as the target device.

[FIG. 7] FIG. 7 is a diagram showing one example of the correspondence between the values of device addresses and group designation for broadcasting.

[FIG. 8] FIG. 8 is a flowchart showing one example of steps of broadcasting.

[FIG. 9] FIG. 9 is a diagram showing the data structure of the reception data RX in a case where a device is accessed using a bridging function.

[FIG. 10] FIG. 10 is a timing chart showing communication control performed when a write is performed to a device.

[FIG. 11] FIG. 11 is a timing chart showing communication control performed when a read is performed from a device.

### DESCRIPTION OF EMBODIMENTS

### Detailed Description

Now, an illustrative embodiment of the present disclosure will be described with reference to the accompanying drawings.

### 1. Communication System

FIG. 1 is a diagram showing the configuration of a communication system 70 according to an illustrative embodiment of the present disclosure. The communication system 70 includes an MCU (micro controller unit) 20, a CAN (controller area network) transceiver 30, a CAN transceiver 40, a semiconductor device 1, N devices 10 (where N is an integer of one or more), a plurality of semiconductor devices 50, and a plurality of semiconductor devices 60. The communication system 70 is, for example, for use on board a vehicle.

A CAN transceiver 40, a semiconductor device 1, devices 10, and semiconductor devices 50 are mounted on a first substrate PB1. A CAN transceiver 40, a semiconductor device 1, devices 10, and semiconductor devices 60 are mounted on a second substrate PB2.

Between the MCU 20 and CAN transceiver 30, communication is performed using UART (universal asynchronous receiver/transmitter). UART is a protocol for exchanging serial data between two devices. In UART, bidirectional communication is performed across two lines between the transmission side and a reception side.

Between the CAN transceivers 30 and 40, communication is performed across a CAN bus 35. CAN is a serial communication protocol standardized in an international standard like ISO 11898.

The CAN transceiver 30 has a TXD (transmission data input) terminal 30A and an RXD (reception data output) terminal 30B. The CAN transceiver 30 outputs, to the CAN bus 35, data input to the TXD terminal 30A, and outputs, from the RXD terminal 30B, data input from the CAN bus 35.

On the first substrate PB1, the CAN transceiver 40 and semiconductor device 1 and semiconductor devices 50 are connected together across a bus BS1. The bus BS1 is used for UART communication. The CAN transceiver 40 has an RXD terminal 40A and a TXD terminal 40B. The CAN transceiver 40 outputs, to the CAN bus 35, data input to the TXD terminal 40B, and outputs, from the RXD terminal 40A, data input from the CAN bus 35.

The semiconductor device 1 is an IC (integrated circuit) that has integrated in it a circuit with a predetermined function and is configured as, for example, an LED (light-emitting diode) driver IC. The semiconductor device 1 has an RX (reception data input) terminal 1A and a TX (transmission data output) terminal 1B. The plurality of semiconductor devices 50 are ICs having integrated in them a circuit with the same function as or a different function from the semiconductor device 1. Like the semiconductor device 1, the semiconductor devices 50 have an RX terminal 50A and a TX terminal 50B.

The RX terminals 1A and 50A are both connected to the RXD terminal 40A. The TX terminals 1B and 50B are both connected to the TXD terminal 40B. Via the bus BS1, reception data RX and transmission data TX can be communicated. The reception data RX and transmission data TX are serial data conforming to UART. The reception data RX output from the RXD terminal 40A is input to the RX terminals 1A and 50A. The transmission data TX output from the TX terminals 1B and 50B is input to the TXD terminal 40B.

The N devices 10 are ICs having integrated in them a circuit with a predetermined function and are configured as, for example, a matrix switch IC.

The semiconductor device 1 has an RXD terminal 1C and a TXD terminal 1D. The RX terminals 10A of the N devices 10 are all connected to the RXD terminal 1C. The TX terminals 10B of the N devices 10 are all connected to the TXD terminal 1D. That is, the RXD terminal 1C and TXD terminal 1D are connected to the RX terminal 10A and TX terminal 10B across a bus (local bus) BS2. Via the bus BS2, reception data BRX and transmission data BTX can be communicated. The reception data BRX and transmission data BTX are serial data.

The bus BS2 as described above are provided for a bridging function, which will be described later. The bridging function allows coping with different protocols between the semiconductor device 1 and the devices 10.

Note that, since the CAN transceiver 40, the semiconductor device 1, the devices 10 and the semiconductor devices 60 on the second substrate PB2 have a similar configuration to those on the first substrate PB1, no overlapping description will be repeated.

### 2. Broadcasting

Broadcasting in the communication system 70 according to the embodiment will be described below. Broadcasting is performed using UART communication between the CAN transceiver 40 and the semiconductor devices 1, 5, and 60.

FIG. 2 is a block diagram of the semiconductor device 1 according to the embodiment of the present disclosure. The semiconductor device 1 includes, as functional blocks, a first receiver 11, a first transmitter 12, a second receiver 13, a second transmitter 14, and a controller 15. Note that, while FIG. 2 depicts only the functional blocks for the communication function in the communication system 70, the semiconductor device 1 can include another functional block. For example, if the semiconductor device 1 is an LED driver, it includes a functional block for driving an LED.

The first receiver 11 receives the reception data RX via the RX terminal 1A. The first transmitter 12 outputs the reception data BRX via the RXD terminal 1C. The second receiver 13 receives transmission data BTX via the TXD terminal 1D. The second transmitter 14 outputs the transmission data TX via the TX terminal 1B.

The controller 15 controls the first receiver 11, the first transmitter 12, the second receiver 13, and the second transmitter 14. The controller 15 has a register 151.

Note that the semiconductor devices 50 and 60 have a configuration similar to that described in FIG. 2 with the first transmitter 12 and the second receiver 13 omitted.

If the semiconductor devices 1, 5, and 60 have different register maps in their respective registers (such as the register 151), it is difficult to perform broadcasting involving a write and a read to and from all the semiconductor devices 1, 5, and 60 through a single session of data transmission from the CAN transceiver 40. Note that a register map denotes the correspondence between addresses and stored data in the register. In the example shown in FIG. 1, if semiconductor devices have the same register map, they are defined as semiconductor devices of the same type; a plurality of semiconductor devices are provided for each different type of semiconductor devices 1, 50, and 60.

To cope with this, in the embodiment, a grouping function is provided that allows grouping of semiconductor devices targeted for broadcasting. FIG. 3 is a register map relating to the grouping function in the register 151 in the semiconductor device 1. Specifically, the register 151 can store eight-bit data per address, and, in FIG. 3, group setting data BCGRP is stored at a predetermined address. The group setting data BCGRP is five-bit data and is data for setting the group of the semiconductor device 1 itself in broadcasting. In FIG. 3, the group setting data BCGRP is stored in the lower five bits of the eight bits. Note that, while the semiconductor devices 50 and 60 have a register map similar to that shown in FIG. 3, the predetermined address mentioned above is not always the same as the one in the semiconductor device 1.

The group setting data BCGRP can take a value from 0 to 31. As shown in FIG. 4, for example, if BCGRP = 1, group 1 is set, and, if BCGRP = 2, group 2 is set. That is, if BCGRP = n, group n is set (where n is any value from 1 to 31). Note that, if BCGRP = 0, no group is set.

For example, if, in each of the semiconductor devices 1 mounted on each of the substrates PB1 and PB2, BCGRP = 1 holds for both substrates PB1 and PB2, then, as shown in FIG. 5, these semiconductor devices 1 are grouped into group 1. In this way, the semiconductor devices 1 of the same type mounted on different substrates PB1 and PB2 can be grouped into the same group.

If, in the plurality of semiconductor devices 50, BCGRP =2 holds for all of them, then, as shown in FIG. 5, the plurality of semiconductor devices 50 are grouped into group 2. Likewise, if, in the plurality of semiconductor devices 60, BCGRP =3 holds for all of them, then, as shown in FIG. 5, the plurality of semiconductor devices 60 are grouped into group 3.

In addition, the group setting is performed based on the group setting data BCGRP stored in the register. Thus, rewriting the group setting data BCGRP using UART communication permits the group setting to be variable. Note that the group setting need not be variable but can be fixed. In that case, for example, group setting can be performed with a resistor externally connected to the semiconductor device.

FIG. 6 is a diagram showing a data structure of the reception data RX in a case where a write is performed with the semiconductor devices 1, 50, and 60 as the target device.

In UART, communication proceeds using data units called frames. As shown in FIG. 6, a frame FR is configured as bit data starting with a start bit S and ending with a stop bit P. The start bit S is a low level, and the stop bit P is a high level. Between the start bit S and the stop bit P bit data with a predetermined number of bits is arranged. In the example shown in FIG. 6, bit data of eight bits is arranged. That is, the frame FR is configured as bit data of 10 bits.

As shown in FIG. 6, the reception data RX has, in order of sequence, a synchronization frame SYNC, a read/write or other frame RWD, a number-of-data frame ND, a register address frame AD, a data frame DT, and a CRC (cyclic redundancy check) frame CR.

The synchronization frame SYNC is bit data for setting a baud rate in the semiconductor device.

The read/write or other frame RWD includes a device address DA, a bridge bit BR, a broadcast/parity bit B/PA, and a read/write bit RW.

The device address DA is bit data indicating the address of the target device (semiconductor device) (i.e., five-bit data in the example shown in FIG. 6). The bridge bit BR is bit data indicating the on/off state of the bridging function of the semiconductor device 1. The broadcast/parity bit B/PA is bit data indicating the on/off state of broadcasting by the semiconductor device 1 or the parity of the data address DA. The read/write bit RW is bit data indicating a read or a write.

If the bridge bit BR = 0, the bridging function is off, and this indicates a normal mode. In this case, the broadcast/parity bit B/PA indicates the on/off state of broadcasting. If the broadcast/parity bit B/PA = 0, broadcasting is off, and, if the broadcast/parity bit B/PA = 1, broadcasting is on.

If the bridge bit BR = 1, the bridging function is on. In this case, the broadcast/parity bit B/PA indicates the parity of the device address DA. This permits error detection in the device address DA. Note that, in the configuration shown in FIG. 1, if the protocol differ among groups in the devices 10 respectively connected to the plurality of semiconductor devices 1, turning on broadcasting by the semiconductor device 1 causes the same reception data RX to be transmitted as the reception data BRX to the devices 10 having different protocols, resulting in incompatible protocols in some devices 10. To avoid this, if the bridging function is turned on, no broadcasting is performed.

The number-of-data frame ND is bit data indicating the number of frames of the data frame DT. The register address frame AD is bit data indicating the address in the register (such as 151). The data frame DT is bit data for writing to the register. Note that the data frame DT is not included in the reception data RX in a read. The CRC frame CR is bit data indicating an error detection code added to the data frame DT.

If BR = 0 and B/PA = 1, that is, if the bridging function is off and broadcasting is on, the device address DA can be used as data indicating a group. For example, as shown in FIG. 7, DA = 1 indicates group 1, and DA = 2 indicates group 2; that is, DA = n indicates group n. Thus, using the device address DA as data indicating a group helps avoid an increase in data traffic. Note that, if BR = 0 and B/PA = 0, that is, if the bridging function is off and broadcasting is off (normal access), the device address DA indicates the original device address.

In a case where broadcasting is performed after group setting is performed for the semiconductor devices 1, 50, and 60 as described above, the reception data RX is transmitted from the CAN transceiver 40 to the semiconductor devices 1, 50, and 60. In that case, the reception data RX is set such that BR = 0 and B/PA = 1, that is, the bridging function is off and the broadcasting is on. Then, the controllers (such as the controller 15) in the semiconductor devices 1, 50, and 60 check whether the group indicated by the device address DA matches the group set for their own semiconductor devices. If those groups match, with their own semiconductor devices taken as targets for broadcasting, it is checked based on the read/write bit RW included in the received reception data RX whether to perform a write or a read. In case of a write, a write is performed to the register based on the data frame DT included in the reception data RX. In case of a read, a read is performed from the register.

For example, as shown in the flowchart in FIG. 8, after the semiconductor devices 1, 50, and 60 are respectively grouped into group 1, 2, and 3 based on the group setting data BCGRP, transmitting the reception data RX with BR = 0, B/PA = 1, and DA = 1 achieves broadcasting for the semiconductor device 1; transmitting the reception data RX with BR = 0, B/PA = 1, and DA = 2 achieves broadcasting for the semiconductor device 50; and transmitting the reception data RX with BR = 0, B/PA = 1, and DA = 3 achieves broadcasting for the semiconductor device 60.

With the embodiment as described above, even if the semiconductor devices 1, 50, and 60 have different register maps in their registers, it is possible to perform broadcasting with the semiconductor devices grouped into groups.

Note that, if, as shown in FIG. 7, the device address DA = 0, broadcasting is performed for all the semiconductor devices 1, 50, and 60. This is effective when the semiconductor devices 1, 50, and 60 have the same register map.

### 3. Bridging Function

In the configuration shown in FIG. 1, the semiconductor device 1 and the N devices 10 are compatible with different protocols. If the CAN transceiver 40 performs a write or a read to or from the devices 10, the reception data RX output from the RXD terminal 40A to the RX terminal 1A includes data corresponding to the protocol in the devices 10. In this case, the semiconductor device 1 turns on the bridging function and outputs intact the data corresponding to the protocol in the devices 10 included in the reception data RX as the reception data BRX from the RXD terminal 1C. Outputting bit data intact means outputting it as it is. In the reception data BRX, the device address of the devices 10 are designated.

If a read is performed, the devices 10 as the target devices (devices designated by the device address) output the transmission data BTX from the TX terminal 10B to the TXD terminal 1D. With the bridging function on, the semiconductor device 1 outputs intact the transmission data BTX as the transmission data TX from the TX terminal 1B.

As described above, with the embodiment of the present disclosure, even if the semiconductor device 1 and the devices 10 have different protocols, the CAN transceiver 40 can perform a write and a read to and from the devices 10.

FIG. 9 is a diagram showing the data structure of the reception data RX when a write or a read is performed for the devices 10 as the target devices. The synchronization frame SYN and the read/write or other frame RWD in the reception data RX in FIG. 9 are as described previously.

In the reception data RX in FIG. 9, the number-of data frame ND indicates, unlike in the case shown in FIG. 6, the number of frames for a condition to end the intact outputting. Control using the number-of-data frame ND will be described later.

In the reception data RX shown in FIG. 9, device data DDT follows the number-of-data frame ND. The device data DDT is data corresponding to the protocol of the devices 10 and is the target of intact outputting as the reception data BRX. The device data DDT includes a device address BDA. The device address BDA indicates the addresses of the devices 10 as the target devices. The position of the device address BDA arranged in the device data DDT is the position corresponding to the protocol of the devices 10.

Now, the control by the semiconductor device 1 for intact outputting, that is, the control with the bridging function on will be described.

FIG. 10 is a timing chart showing communication control performed when a write is performed for the devices 10. FIG. 10 depicts, from top down, the reception data RX, a reception data output selection signal (RX output select), a transmission data output selection signal (TX output select), the reception data BRX, the transmission data BTX, and the transmission data TX (the same applies to FIG. 11). The reception data RX has the same configuration as that shown in FIG. 9.

The reception data RX is received by the first receiver 11 (FIG. 2). On receiving the start bit S1 (low level) at the head of the reception data RX, the controller 15 recognizes that it has started to receive reception data RX. Then, the controller 15 recognizes based on the bridge bit BR included in the reception data RX that the bridging function is on and recognizes based on the read/write bit RW that a write is to be performed.

After that, when the number-of-data frame ND is received, at the stop bit P1 in the number-of-data frame ND, the controller 15 raises the reception data output selection signal in the register 151 from low level to high level (at time t1). This starts the intact outputting of the reception data RX, so that the first receiver 11 and the first transmitter 12 output the reception data RX as it is as the reception data BRX. That is, the device data DDT (FIG. 9) is output intact.

When the reception data output selection signal turns to high level, the controller 15 starts to count the number of frames in the reception data RX received (i.e., the number of frames in the device data DDT). When the counted number of frames reaches the number of frames that the received number-of-data frame ND indicates, the controller 15 switches the reception data output selection signal to low level to stop intact outputting (at time t2). From this point on, the reception data BRX is fixed at high level.

FIG. 11 is a timing chart showing communication control performed when a read is performed for the devices 10. In that case, the reception data RX has the structure shown in FIG. 9.

On receiving the start bit S1 (low level) at the head of the reception data RX, the controller 15 recognizes based on the bridge bit BR included in the reception data RX that the bridging function is on and recognizes based on the read/write bit RW that a read is to be performed.

After that, when the number-of-data frame ND is received, at the stop bit P1 in the number-of-data frame ND, the controller 15 raises both the reception data output selection signal and the transmission data output selection signal in the register 151 from low level to high level (at time t1). This starts the intact outputting of the reception data RX and the transmission data BTX. The first receiver 11 and the first transmitter 12 output the reception data RX as it is as the reception data BRX. That is, the device data DDT (FIG. 9) is output intact. After the output of the reception data BRX is complete, the second receiver 13 and the second transmitter 14 output intact the transmission data BTX transmitted from the devices 10 as the transmission data TX.

When the reception data output selection signal and the transmission data output selection signal turn to high level, the controller 15 starts to count the sum of the numbers of frames in the reception data RX received and in the transmission data BTX received. When the counted number of frames reaches the number of frames that the received number-of-data frame ND indicates, the controller 15 switches both the reception data output selection signal and the transmission data output selection signal to low level to stop intact outputting (at time t2). From this point on, the reception data BRX is fixed at high level, and the transmission data TX is fixed at Hi-z (high impedance).

### 4. Others

The various technical features disclosed in the present description can be implemented in any manner other than as specifically described above and allow for various modifications without departure from the spirit of their technical ingenuity. That is, the embodiments described above should be taken to be in every aspect illustrative and not restrictive. The technical scope of the present disclosure should not be limited to the embodiment described above but to be understood to be defined by the appended claims and to encompass any variations within a scope equivalent in significance to the scope of those claims.

### 5. Notes

As described above, according to one aspect of the present disclosure, a semiconductor device (1) includes a receiver (11) configured to externally receive communication data (RX) by serial communication, and a controller (15). In the semiconductor device, its group is settable. The communication data includes first data (B/PA) indicating whether broadcasting is in progress and second data (DA) indicating the group of a semiconductor device. If the group set in the controller’s own semiconductor device matches the group indicated by the second data, the controller judges that broadcasting is in progress for the controller’s own semiconductor device. (A first configuration.)

With this configuration, it is possible to perform broadcasting with semiconductor devices of the same type grouped into a group, thus achieving the object of performing effective broadcasting using serial communication.

In the first configuration described above, if the first data (B/PA) indicates that not broadcasting but normal access is in progress, the second data (DA) can indicate the device address of a semiconductor device that is a target. (A second configuration.)

In the first or second configuration described above, if the first data (B/PA) indicates that broadcasting is in progress, the second data (DA) can be set so as to indicate that broadcasting is in progress for all semiconductor devices that receive the communication data. (A third configuration.)

In the semiconductor device according to any one of the first to third configurations that is connectable via a first bus (BS1) to a transmitter (40) provided outside and that is connectable via a second bus (BS2) to a device (10) provided outside, the semiconductor device can include a first receiver (11) configured to be capable of receiving the communication data from the transmitter via the first bus and a first transmitter (12) configured to be connectable to the device via the second bus. The first receiver and the first transmitter can be configured such that, if bridging selection data (BR) included in the communication data indicates that intact outputting is on to output bit data intact between the first and second buses, data (DDT) corresponding to the protocol of the device included in the communication data is output intact to the second bus. (A fourth configuration.)

In the fourth configuration described above, if the bridging selection data (BR) indicates that intact outputting is off, the first data (B/PA) can indicate whether broadcasting is in progress, and, if the bridging selection data indicates that intact outputting is on, the first data can indicate a parity bit. (A fifth configuration.)

In any one of the first to fifth configurations described above, the first data (B/PA) and the second data (DA) can be included in the same frame (RWD) in the communication data along with bit data (RW) indicating a read or a write. (A sixth configuration.)

In any one of the first to sixth configurations described above, the semiconductor device can further include a register (151), and the group can be settable based on setting data (BCGRP) stored in the register. (A seventh configuration.)

According to another aspect of the present disclosure, a communication system (70) includes a semiconductor device (1, 50, 60) according to any of the first to seventh configurations described above and a transmitter (40) configured to transmit the transmission data. With semiconductor devices with the same register map taken as semiconductor devices of the same type, a plurality of semiconductor devices are provided for each of different types of the semiconductor devices (1, 50, 60). (An eighth configuration.)

In the eighth configuration described above, the semiconductor devices (1) of the same type can be arranged on, so as to be distributed among, a plurality of substrates (PB1, PB2). (A ninth configuration.)

### INDUSTRIAL APPLICABILITY

The present disclosure finds applications in, for example, communication systems for use on board a vehicle.

### REFERENCE SIGNS LIST

1 semiconductor device

1A RX terminal

1B TX terminal

1C RXD terminal

1D TXD terminal

10 device

10A RX terminal

10B TX terminal

11 first receiver

12 first transmitter

13 second receiver

14 second transmitter

15 controller

30 CAN transceiver

30A TXD terminal

30B RXD terminal

35 CAN bus

40 CAN transceiver

40A RXD terminal

40B TXD terminal

50 semiconductor device

60 semiconductor device

70 communication system

151 register

BS1, BS2 bus

PB1 first substrate

PB2 second substrate

1. A semiconductor device comprising:
a receiver configured to externally receive communication data by serial communication; and
a controller,
wherein,
in the semiconductor device, a group thereof is settable,
the communication data includes:
first data indicating whether broadcasting is in progress; and
second data indicating a group of a semiconductor device, and,
if the group set in the controller’s own semiconductor device matches the group indicated by the second data, the controller judges that the broadcasting is in progress for the controller’s own semiconductor device.

2. The semiconductor device according to claim 1, wherein,
if the first data indicates that not broadcasting but normal access is in progress, the second data indicates a device address of a semiconductor device that is a target.

3. The semiconductor device according to claim 1, wherein,
if the first data indicates that broadcasting is in progress, the second data can be set so as to indicate that broadcasting is in progress for all semiconductor devices that receive the communication data.

4. The semiconductor device according to claim 1 that is connectable via a first bus to a transmitter provided outside and that is connectable via a second bus to a device provided outside, the semiconductor device comprising:
a first receiver configured to be capable of receiving the communication data from the transmitter via the first bus; and
a first transmitter configured to be connectable to the device via the second bus,
wherein
the first receiver and the first transmitter are configured such that, if bridging selection data included in the communication data indicates that intact outputting is on to output bit data intact between the first and second buses, data corresponding to a protocol of the device included in the communication data is output intact to the second bus.

5. The semiconductor device according to claim 4, wherein,
if the bridging selection data indicates that the intact outputting is off, the first data indicates whether the broadcasting is in progress, and,
if the bridging selection data indicates that the intact outputting is on, the first data indicates a parity bit.

6. The semiconductor device according to claim 1, wherein
the first and second data are included in a same frame in the communication data along with bit data indicating a read or a write.

7. The semiconductor device according to claim 1 further comprising:
a register,
wherein
the group is settable based on setting data stored in the register.

8. A communication system comprising:
the semiconductor device according to claim 1; and
a transmitter configured to transmit the communication data,
wherein,
with semiconductor devices with a same register map taken as semiconductor devices of a same type, a plurality of the semiconductor devices are provided for each of different types of the semiconductor device.

9. The communication system according to claim 8, wherein
the semiconductor devices of the same type are arranged on, so as to be distributed among, a plurality of substrates.
